(19) United States
(12) Patent Application Publication
(10) Pub. No.: US 2026/0016036 A1
(43) Pub. Date: Jan. 15, 2026

(54) QUICK-CONNECT TOP DRESS SEAL ASSEMBLY

(71) Applicant: Brinly-Hardy Company, Inc., Jeffersonville, IN (US)

(72) Inventors: Nicholas R. Carroll, Georgetown, IN (US); Scott Carpenter, New Albany, IN (US)

(21) Appl. No.: 18/767,614

(22) Filed: Jul. 9, 2024

(51) Int. Cl. F16B 7/18; A01C 17/00

(52) U.S. Cl. CPC F16B 7/18; A01C 17/005

(57) ABSTRACT

A quick-connect top dress seal assembly for converting a standard broadcast spreader into a top dress spreader. The assembly includes a seal base, a compression spring, a seal lock, and a seal cap. The seal base couples to the bottom of a hopper of the spreader over a shaft of the spreader, and includes a ledge near one end and tabs near the other end. The compression spring fits inside the seal base and acts against a ledge in the seal base. A seal lock resides within the seal base and is held in place, against the spring force, via the tabs and a pin seat. A seal cap couples to the seal base to prevent entry of sand therewithin.

### BACKGROUND

Various devices exist for spreading or broadcasting materials such as fertilizer or grass seed onto a lawn or other area. Spreaders (whether of the drop or broadcast variety) are typically used for this purpose and can evenly distribute fertilizer and/or grass seed over a particular area. Drop spreaders distribute the material in even, accurate rows and typically cover a small area. Broadcast (rotary) spreaders distribute the material in a fan-like pattern in all directions, and therefore cover a much larger area than do drop spreaders.

Top dressing refers to the application of a thin layer of material (such as sand, soil, compost, or the like) to the top of a lawn or grass. Top dressing is often used on golf courses and other grasses that are mowed extremely short as it helps keep the turf healthy and green. However, the use of sand as a top dressing poses significant issues for the device used to spread the top dressing. This is particularly true when users try to use ordinary broadcast spreaders, which are intended for grass seed and/or fertilizer, to top dress the lawn with sand. The smaller, much coarser sand particles find their way past the spreader’s seal surrounding the rotary shaft and cause damage to the rotating shaft.

A need exists for an apparatus for quickly converting the rotary shaft of a standard broadcast spreader into a device suitable for top dressing a lawn with sand.

### SUMMARY

The following disclosed system, components, and methods facilitate the easy and rapid conversion of a standard spreader into a top dress spreader, and vice versa. The herein-described embodiments address the problems associated with the art by providing a system that easily facilitates converting a standard spreader into a top dress spreader while preventing damage to the bearing in the rotating shaft of the spreader.

In an embodiment, a top dress seal assembly is provided comprising a seal base having a first end and a second end and an opening therewithin along a longitudinal axis of the seal base between the first end and the second end. The first end is configured to be positioned over a rotating shaft of a spreader and the second end has one or more tabs inwardly projecting toward the longitudinal axis. The second end also having a helical engagement structure thereon. The assembly further includes a compression spring having a first end and a second end and being configured to be received within the opening in the seal base. The assembly also includes a seal lock configured to be received within the seal base, the seal lock having a first end, a second end, and a substantially cylindrical body between the first end and the second end along a longitudinal axis of the seal lock and having a slot in the first end dividing the first end into a first arm and a second arm. The first end is configured to bear against the second end of the compression spring. The assembly also includes a seal cap having a first end and a second end, wherein the first end has a helical engagement structure configured to couple to the helical engagement structure of the second end of the seal base.

In an embodiment, a top dress seal assembly is provide that comprises a seal base having a first end and a second end and an opening therewithin along a longitudinal axis of the seal base between the first end and the second end. The first end is configured to be positioned over a rotating shaft of a spreader and further includes a ledge therewithin, and the second end has one or more tabs projecting toward the longitudinal axis and also includes a helical engagement structure on an external surface. The assembly also includes a compression spring having a first end and a second end and being configured to be received within the opening in the seal base concentrically around the longitudinal axis. The assembly also includes a seal lock configured to be received within the seal base, the seal lock having a first end, a second end, and a substantially cylindrical body between the first end and the second end along the longitudinal axis. The seal lock further comprises a slot in the first end dividing the first end into a first arm and a second arm, wherein the first arm and the second arm further comprise a ledge extending radially outwardly. The slot is generally parallel to the longitudinal axis and is configured to receive a pin of a rotating shaft of the spreader. The seal lock further comprises a horizontal slot in communication with the slot, and a pin seat in communication with the horizontal slot. The assembly also includes a seal cap having a first end and a second end, wherein the first end has a helical engagement structure configured to couple to the helical engagement structure of the second end of the seal base.

In an embodiment, a method of removably coupling a top dress seal assembly to a rotating shaft of a spreader is provided, comprising multiple steps. One step includes providing a seal base having a first end and a second end and a longitudinal opening therethrough, wherein the first end further comprises a ledge and the second end further comprises tabs protruding inwardly within the longitudinal opening, and the second end further includes a first coupling structure thereon. Another step includes providing a compression spring having a first end and a second end. Another step includes providing a seal lock having a first end and a second end, wherein the first end further comprises a slot separating the first end into a first arm and a second arm, and wherein the first arm and the second arm further comprise a ledge protruding outwardly away from a longitudinal axis, wherein the seal lock further comprises a horizontal slot in communication with the slot, and further comprises a pin seat in communication with the horizontal slot. Another step includes providing a seal cap having a first end and a second end wherein the first end is an open cylindrical portion having a second coupling structure thereon. Another step includes inserting the compression spring into the opening of the seal base so that the first end of the compression spring bears against the ledge. Another step includes inserting the first end of seal lock into the second end of the seal base by squeezing the first arm and the second arm together to reduce a dimension therebetween to enable pushing the seal lock past the tabs of the seal base such that a top surface of the ledge bears against a lower surface of the tabs due to a spring force of the compression spring. Another step includes inserting the first end of the seal base over a rotating shaft of a spreader such that the rotating shaft resides coaxially within the seal base, the compression spring, and the seal lock. Another step includes aligning a pin of the rotating shaft with the slot of the seal lock. Another step includes pushing the seal lock against the spring force of the compression spring until the pin reaches the horizontal slot. Another step includes rotating the seal lock toward the pin seat. Another step includes releasing force on the seal lock to enable the pin to move into the pin seat.

These and other advantages and features are set forth in the claims annexed hereto and forming a further part hereof. However, for a better understanding of the invention, and of the advantages and objectives attained through its use, reference should be made to the figures, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a perspective view of a broadcast spreader of the walk-behind variety showing the assembly of the present disclosure mounted therewithin.

FIG. 2A is a close-up perspective view of the bottom of the hopper of the broadcast spreader of FIG. 1 without the assembly.

FIG. 2B is a close-up perspective view of the bottom of the hopper of the broadcast spreader of FIG. 1 with the assembly.

FIG. 2C is a close-up side perspective view of the bottom of the spreader of FIG. 1.

FIG. 3 is a perspective view of the assembly according to an embodiment.

FIG. 4 is an exploded view of the assembly according to an embodiment.

FIG. 5A is a bottom perspective view of the seal base according to an embodiment.

FIG. 5B is a top perspective view of the seal base according to an embodiment.

FIG. 6 is a bottom perspective view of the seal lock according to an embodiment.

FIG. 7 is a section view of the assembly, taken at line 7-7 of FIG. 3, according to an embodiment.

It should be understood that the drawings are not necessarily to scale and that the embodiments are sometimes illustrated by graphic symbols, phantom lines, diagrammatic representations and fragmentary views. In certain instances, details that are not necessary for an understanding of the embodiments described and claimed herein, or which render other details difficult to perceive, may have been omitted. It should be understood, of course, that the scope of the claims is not to be limited to the particular embodiments illustrated in the figures. Indeed, it is expected that persons of ordinary skill in the art may devise a number of alternative configurations that are similar and equivalent to the embodiments shown and described herein without departing from the spirit and scope of the claims.

### DETAILED DESCRIPTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Therefore, specific structural and functional details disclosed herein are not to be interpreted as limiting, but merely as a representative basis for teaching one skilled in the art to variously employ the present invention.

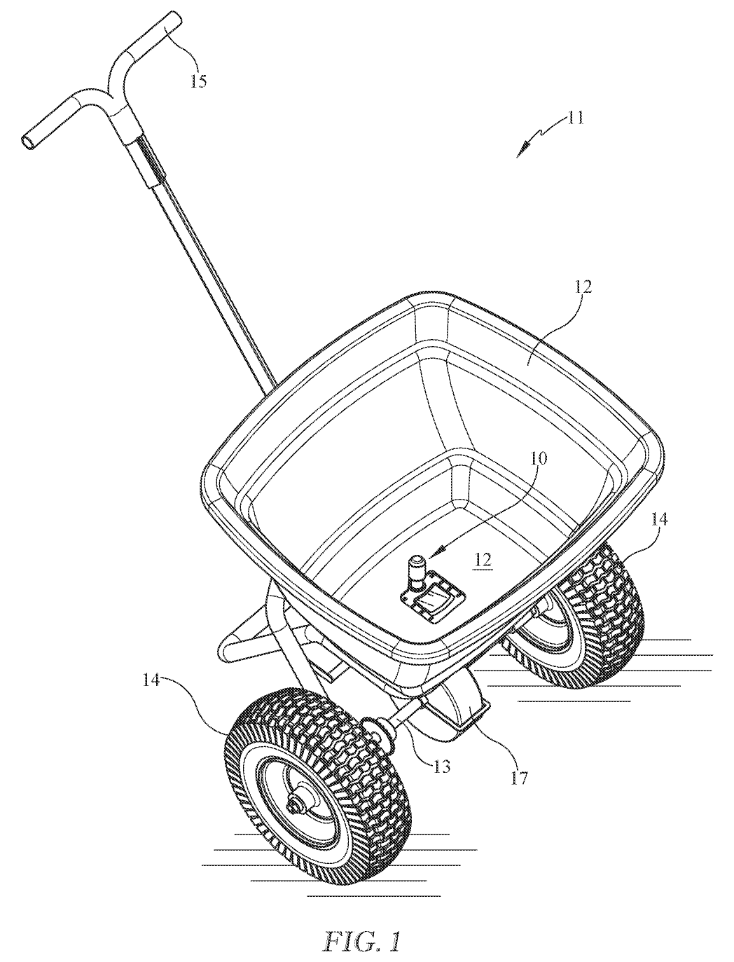

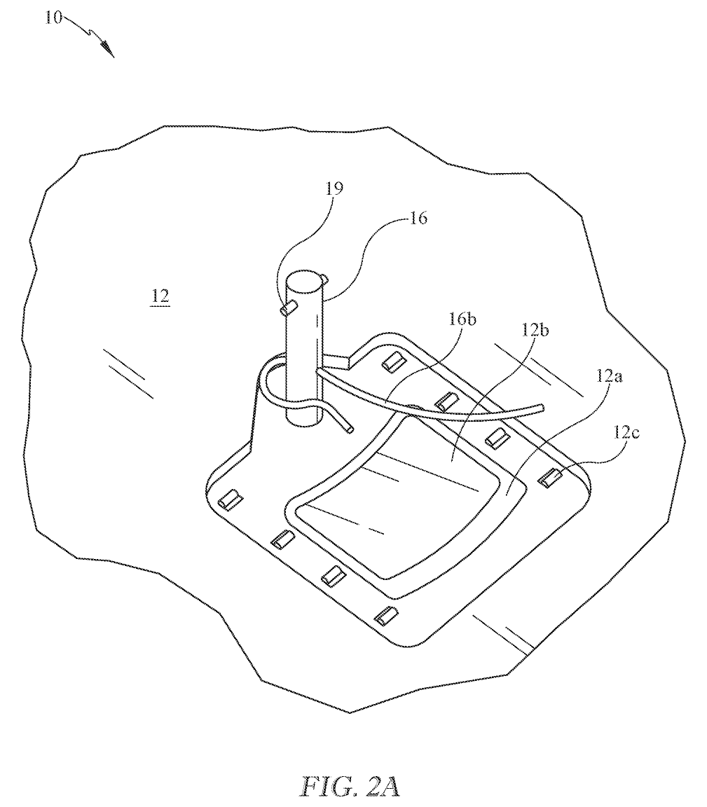

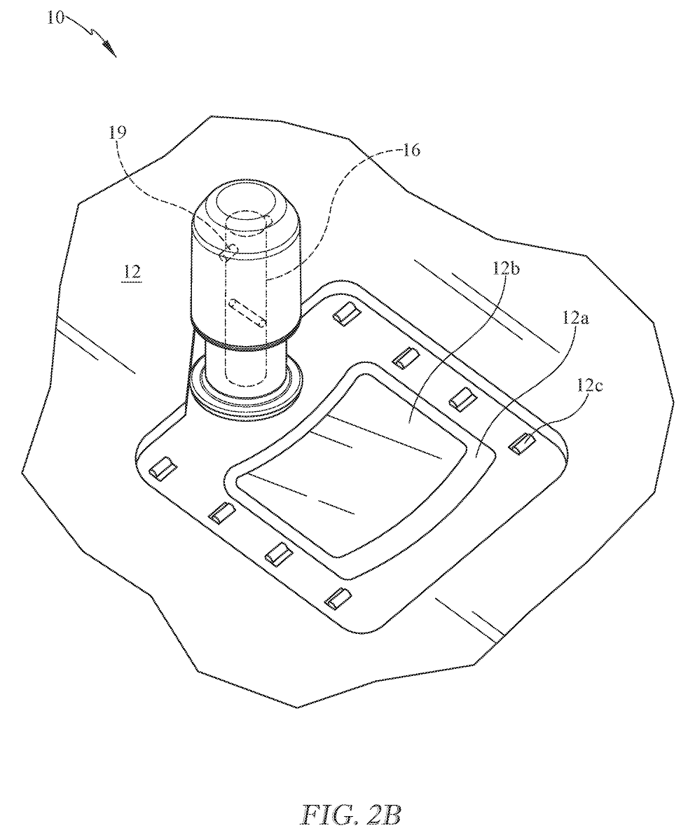

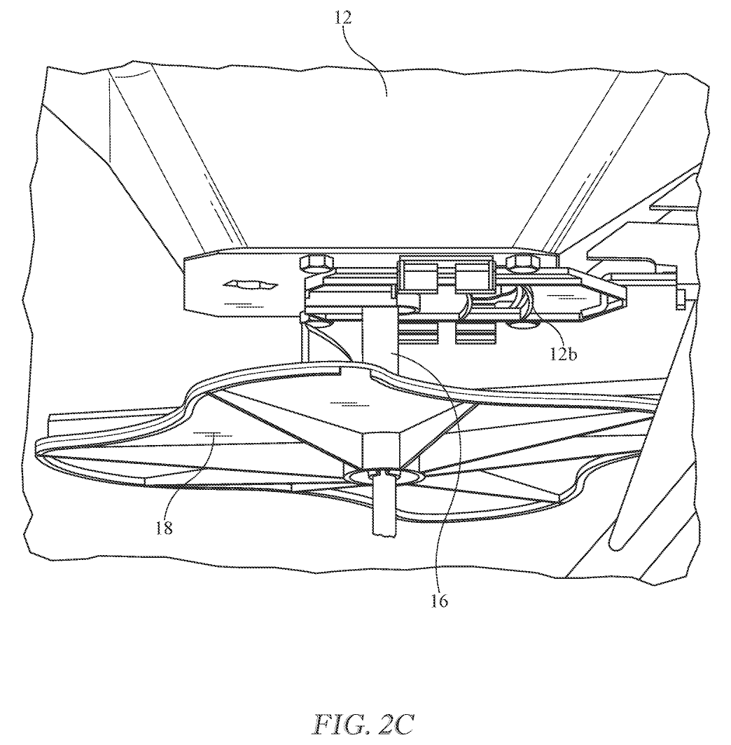

Turning now to the drawings, wherein like numbers denote like parts throughout the several views, FIG. 1 illustrates a perspective view of a spreader 11 that can utilize embodiments of the assembly described herein. FIG. 2A shows a close-up of a portion of the bottom of a spreader 11 that does not include an assembly 10. FIG. 2B shows a close-up of a portion of the bottom of a spreader 11 that includes an assembly 10. A walk-behind spreader 11 is depicted, but the spreader 11 can be any type of spreader, including hand-held, tow-behind, ride-on, and the like. As shown, the spreader 11 generally includes a hopper 12 mounted above an axle 13. The axle 13 connects wheels 14 for providing movement across a lawn. The spreader 11 also can include a handle 15 for the user to push or pull the spreader 11 across a lawn. The axle 13 further includes a shaft 16 disposed substantially vertically and connected to the axle 13 via a gear box 17. As the wheels 14 turn on the axle 13, the gear box 17 converts horizontal rotation of the axle 13 into vertical rotation of the shaft 16.

In common spreaders (FIG. 2A), the shaft 16 includes one or more holes 16a into which one or more agitators 16b can be inserted protruding radially outwardly from the shaft 16. These agitators 16b serve to break up the grass seed/fertilizer within the hopper 12 so as to allow the material to flow out the bottom of the hopper 12, through an opening 12a, past a gate 12b, and onto the fan 18, which rotates along with the shaft 16, as shown in FIG. 2C. The gate 12b is moveable via one or more gate guides 12c to adjust the size of the opening 12a as desired. As the material hits the fan 18 that is rotating, the material is spread outwardly from the spreader 11 and onto the lawn. As will be described below, in some embodiments of the present disclosure, the shaft 16 can also be fitted with a pin 19 (FIG. 2B) that extends radially outwardly from the shaft 16 such that the distance from the center of the shaft 16 to the outer end of the pin 19 is greater than the outer diameter of the shaft 16.

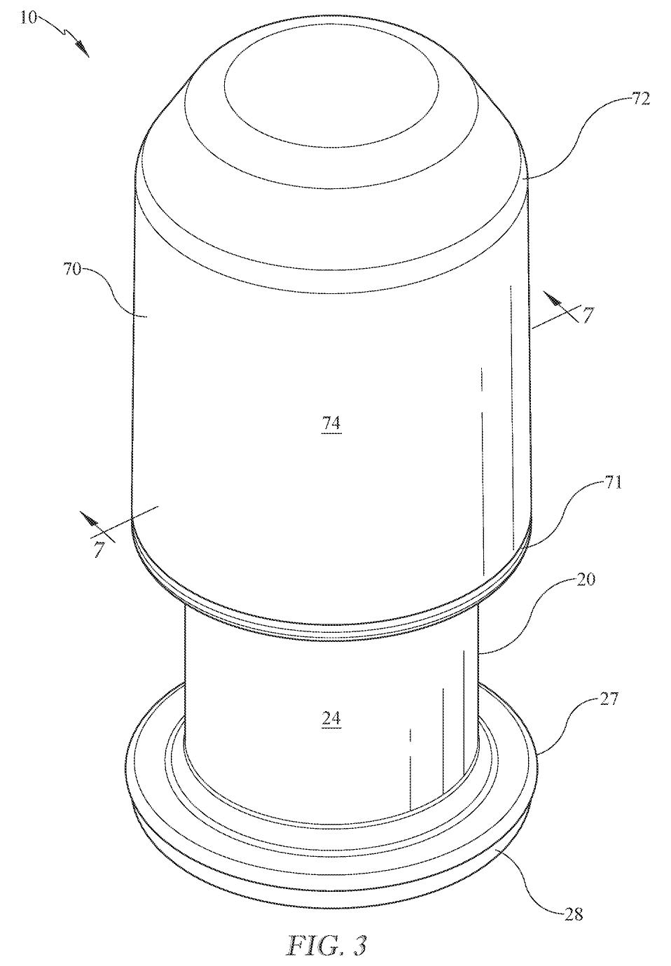

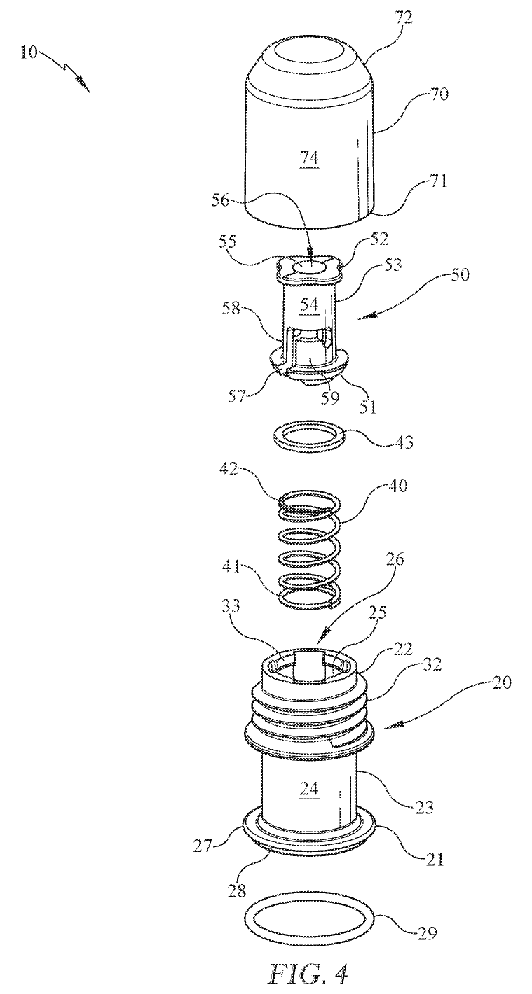

With general reference to FIGS. 3-4, an embodiment of a quick-connect top dress seal assembly 10 is shown. The assembly 10 is configured to easily be installed/removed from the base of the hopper 12 of the spreader 11, as will be described. The assembly 10 includes a seal base 20, a compression spring 40, a seal lock 50, and a seal cap 70.

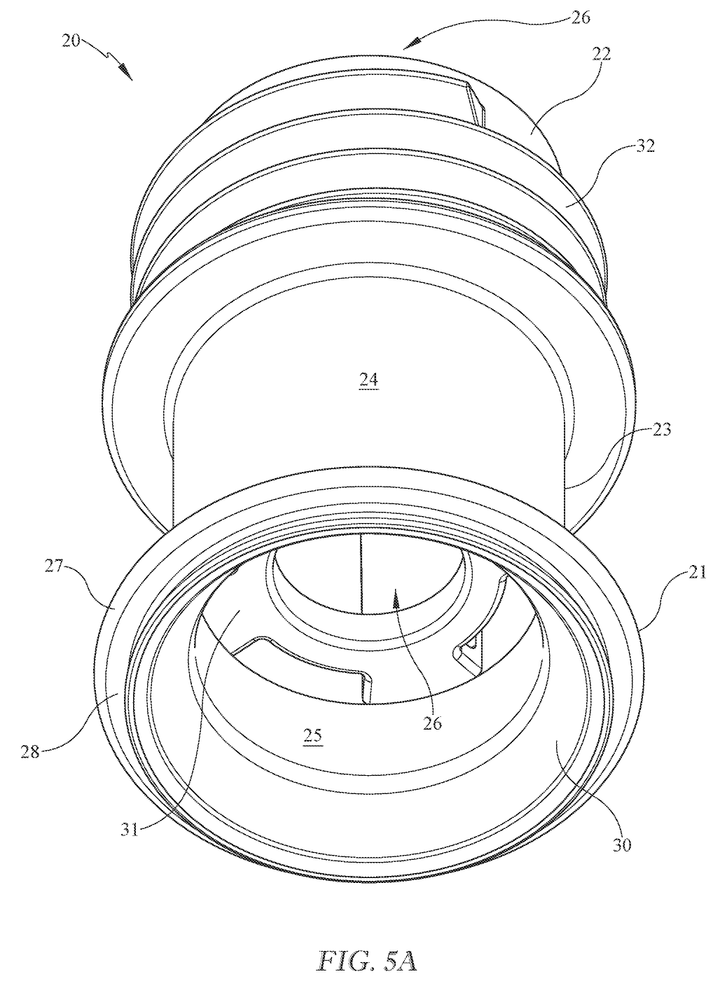

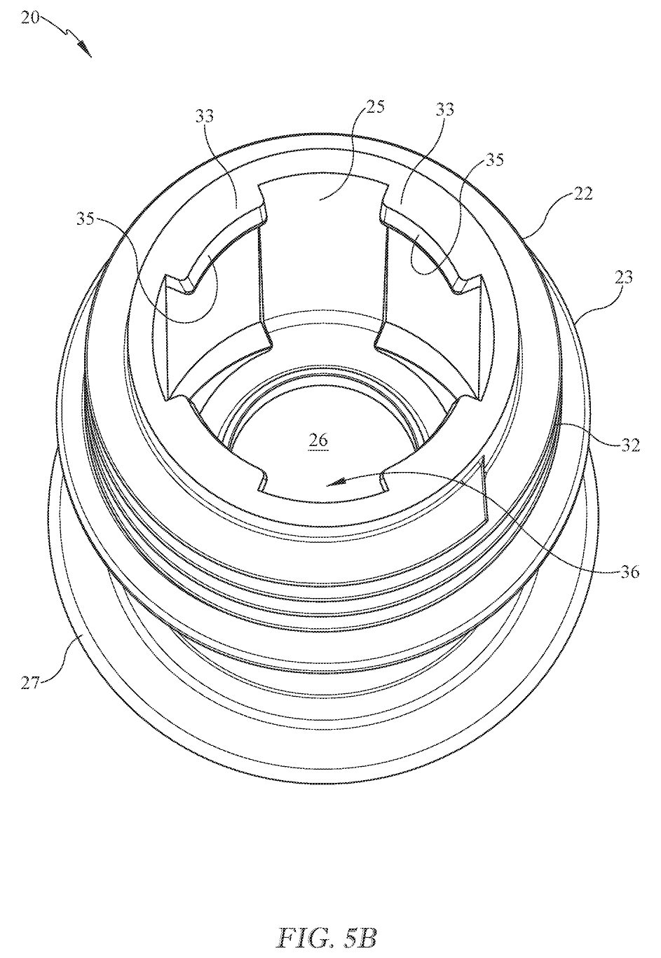

Referring to FIGS. 5A-5B, the seal base 20 has a first end 21 and a second end 22 and a generally open cylindrical body 23 having an outer surface 24 and an inner surface 25. A longitudinal opening 26 extends from the first end 21 to the second end 22. The first end 21 includes a lip 27 for seating against a surface of the hopper. The lip 27 can include a recess 28 to receive an O-ring 29 to facilitate a better seal between the seal base 20 and the hopper. The inner surface 25 near the first end 21 can include a tapered section 30 that transitions the lip 27 toward the inner surface 25 in the body 23. A ledge 31 is disposed within the opening 26 near the first end 21. The ledge 31 protrudes radially from the inner surface 25 toward the central longitudinal axis of the opening 26. The ledge 31 provides a surface against which the compression spring 40 can act, as will be described below.

Referring now to FIG. 5B, the second end 22 can include a helical engagement structure 32 on either the outer surface 24 or the inner surface 25. In the embodiment shown in the figures, the helical engagement structure 32 is located on the outer surface 24 at the second end 22. The inner surface 25 at or near the second end 22 includes tabs 33 disposed radially away from the inner surface 25 and toward the longitudinal cylindrical axis. The tabs 33 have a lower surface 34 that faces toward the first end 21 and a radial surface 35 that resides closer to the longitudinal cylindrical axis than is the inner surface 25. That is, the diameter between the radial surfaces 35 of opposing tabs 33 is less than the diameter of the inner surface 25. In the embodiment shown in the figures, there are four tabs 33 spaced evenly about the circumference of the second end 22. Between each tab or adjacent pair of tabs 33 is a gap 36. The number of tabs 33 can be less than or greater than four, but the preferred embodiment shown includes four tabs 33.

The seal base 20 can be made from many materials, including, without limitation, various types of plastics, polymers, metals, metal alloys, ceramics, wood, and composites. One common preferred material that can be used for the seal base 20 is plastic.

Referring again to FIG. 4, the compression spring 40 is shown as a coil spring. The compression spring 40 has a first end 41 and a second end 42 and, when assembled, resides within the opening 26. The size and stiffness of the compression spring 40 can be a matter of design choice. The first end 41 of the compression spring 40 is configured to bear against the ledge 31 inside the opening 26. The compression spring 40 is made from materials that are common for springs, such as various types of steel (including spring steel), brass, bronze, and plastic. One common preferred material that can be used for the spring 40 is stainless steel.

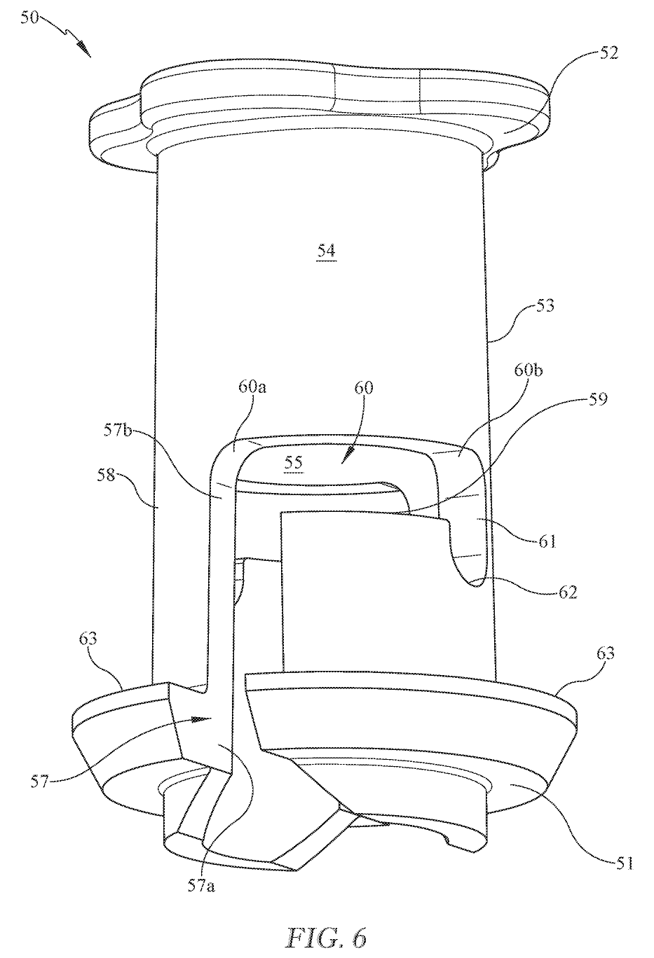

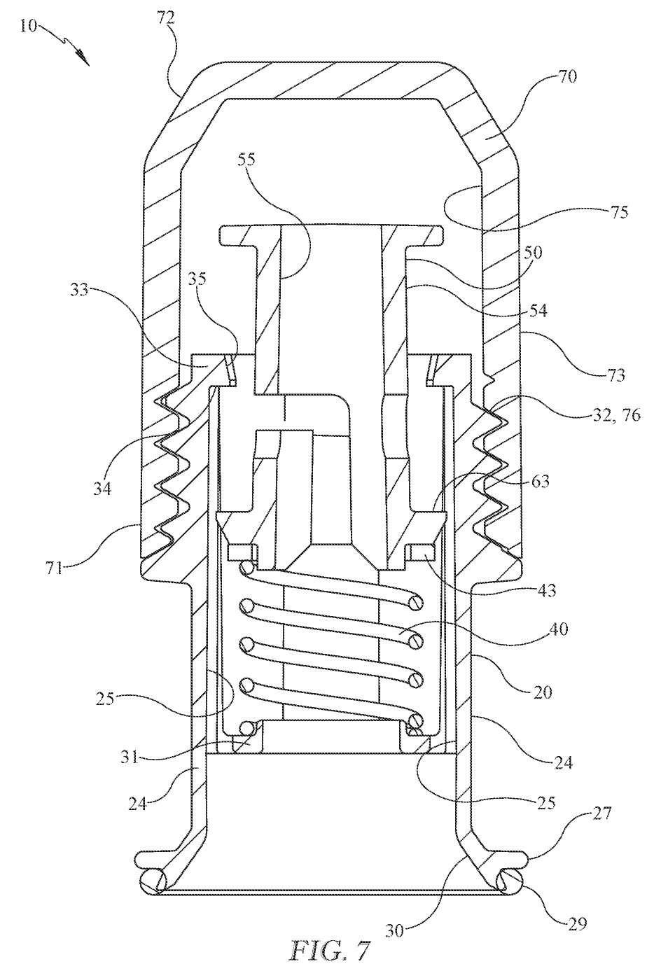

Referring now to FIGS. 6-7, the seal lock 50 is a generally open cylindrical member having a first end 51 and a second end 52 and a generally open cylindrical body 53 having an outer surface 54 and an inner surface 55. A longitudinal opening 56 extends from the first end 51 to the second end 52. The diameter of the inner surface 55 is sized to accommodate the shaft 16 of a spreader, and is generally anywhere from between approximately 0.125 inches to approximately 1 inch, depending on the diameter of the spreader. Typically, such diameter is between approximately 0.25 inches to approximately 0.75 inches, and most preferably is between approximately 0.375 inches to approximately 0.5 inches.

The first end 51 of the body 53 of the embodiment shown in the figures is bifurcated by a slot 57. The slot 57 separates the body 53 into two depending arm portions, first arm 58 and second arm 59. As the slot 57 divides the body 53 into two arms, the slot 57 can be understood as being the border between the first arm 58 and the second arm 59. In each of the first arm 58 and the second arm 59, the slot 57 has a slot first end 57a where the slot 57 exits the first end 51 of the body 53. The slot 57 also has a second end 57b somewhere along the length of the body 53 toward the second end 52. At or near the slot second end 57b, a horizontal slot 60 joins the slot 57. The horizontal slot 60 extends circumferentially around the body 53 from a horizontal slot first end 60a to a horizontal slot second end 60b. At or near the horizontal slot second end 60b, a pin seat 61 exists that includes a bottom surface 62 that is located closer to the first end 51 of the seal lock 50 than is the horizontal slot 60. At or near the first end 51 of the body 53, the first arm 58 and second arm 59 include a ledge 63 that extends radially outwardly from the outer surface 54. The outer surface of the ledge 63 has a diameter that is larger than the internal diameter of the tabs 33 (that is, the diameter between opposing radial surfaces 35) of the seal base 20, as will be described.

The seal lock 50 can be made from many materials, including, without limitation, various types of plastics, polymers, metals, metal alloys, ceramics, wood, and composites. One common preferred material that can be used for the seal lock 50 is plastic. The seal lock 50 is preferably made of a material that has some amount of flex in the first arm 58 and second arm 59 in the presence of slot 57. This flex allows the first arm 58 and second arm 59 to be flexed or “squeezed” together slightly so as to reduce the outer diameter of the ledge 63 to a size that allows the ledge 63 to be inserted past the tabs 33 and into the seal base 20 between the tabs 33. Once the ledge 63 has been inserted past the tabs 33, the natural spring flex of the material moves the first arm 58 and second arm 59 back to their original configuration in which the outer diameter of the ledge 63 is greater than the inner diameter of the tabs 33.

Referring again to FIGS. 3-4, the seal cap 70 is a generally cylindrical member having a first end 71 and a second end 72 and a generally cylindrical body 73 having an outer surface 74 and an inner surface 75. The first end 71 is an open end, while the second end 72 is a closed end. The first end 71 includes a helical engagement structure 76 thereon that is configured to mate with or engage the helical engagement structure 32 at the second end 22 of the seal base 20.

The seal cap 70 can be made from many materials, including, without limitation, various types of plastics, polymers, metals, metal alloys, ceramics, wood, and composites. One common preferred material that can be used for the seal cap 70 is plastic.

### Assembly and Use

As stated, a benefit of the assembly 10 according to the various embodiments is that a seed/fertilizer spreader can be easily converted into a top dressing spreader 11 for top dressing a lawn with sand. To convert the spreader 11, a user will first obtain an assembly 10 (or assemble the components), which includes a seal base 20, a compression spring 40, a seal lock 50, and a seal cap 70. The compression spring 40 is placed inside the seal base 20 such that the first end 41 resides atop the ledge 31. If desired, the user can place a washer 43 atop the second end 42 of the compression spring 40.

Next, the seal lock 50 is installed within the seal base 20. To do this, the user orients the seal lock 50 such that the first end 51 is oriented toward the second end 22 of the seal base 20. The user compresses or squeezes the first arm 58 and second arm 59 to make the diameter of the ledge 63 transition from its first configuration (at rest) to its second configuration (after compression). In the second configuration, the diameter of the ledge 63 is less than the diameter between the radial surfaces 35 of opposing tabs 33. When this occurs, the first arm 58 and second arm 59 can be inserted between the tabs 33 and into contact with the washer 43 (or, if no washer is present, then the second end 42 of the compression spring 40). Continued pushing of the seal lock 50 into the opening 26 within the inner surface 25 of the seal base 20 against the spring force of the compression spring 40 then seats the seal lock 50 within the seal base 20. The ledge 63 will then be retained below the lower surface 34 of the tabs 33 under action of the compression spring 40, thus coupling together the seal lock 50 and the seal base 20.

Next, the user prepares the spreader 11 for receiving the assembly 10 by removing the agitators 16b from the shaft 16. The user then places the seal base 20 (with the seal lock 50) over the shaft 16 in the bottom of the hopper 12. If an O-ring 29 is used, the O-ring 29 is seated into the recess 28 of the body 23 of the seal base 20. The seal base 20 is placed over top of the shaft 16 and moved downwardly until the O-ring 29 seats on a surface of the hopper 12. In so doing, the shaft 16 goes through an opening in the ledge 31, through the inside of the compression spring 40, and into the longitudinal opening 56 of the seal lock 50.

The user then locks the seal lock 50 to the shaft 16. To do this, the user aligns the pin 19 of the shaft 16 with the slot 57 of the seal lock 50. The user then pushes the seal lock 50 against the spring force of the compression spring 40 toward the first end 21 of the seal base 20 until the pin 19 reaches the horizontal slot 60. Next, the user rotates the seal lock 50 to move the pin 19 into the horizontal slot second end 60b. At this point, the user releases pressure against the spring force so that the spring force then moves the pin 19 into the pin seat 61. When pin 19 resides in pin seat 61 under force of the compression spring 40, the entire assembly 10 is held firmly against the surface of the hopper 12. In alternative embodiments, the shaft 16 may not have any pins 19 that are part of the shaft 16 and protrude therefrom. In such cases, a separate pin can be inserted all the way through the pin seat 61 such that

The seal cap 70 is then installed atop the seal base 20. Helical engagement structures 32 and 76 are mated, thus joining seal cap 70 to seal base 20, with seal lock 50 inside. It should be noted that in the embodiment shown in the figures, the mating of the seal cap 70 to the seal base 20 is via helical engagement structures (i.e., threads). This is not required, as any form of removable coupling between the two structures can be used (e.g., without limitation, push fit, snap fit, push-and-turn fit, cam lock, spring lock, and the like). With the help of O-ring 29, and the closed nature of the seal cap 70 on seal base 20, under the spring force of the compression spring 40, the assembly 10 provides a good seal around the base of the shaft 16. Thus, when sand is placed in the hopper 12 and the spreader 11 for top dressing as the spreader 11 is moved along the lawn, the assembly 10 prevents ingress of sand into the area of the shaft 16.

An added benefit of the assembly 10 is that the top dressing spreader 11 can be easily converted back to a standard spreader 11 by simply removing the assembly 10 from the spreader 11 and reinstalling the agitators 16b in the holes 16a of the shaft 16. Thereupon, the spreader 11 can be used as a normal grass seed/fertilizer spreader with one or more agitators 16b.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It is to be understood that the embodiments are not limited in its application to the details of construction and the arrangement of components set forth in the description or illustrated in the drawings. The invention is capable of other embodiments and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

The foregoing description of several embodiments of the invention has been presented for purposes of illustration. It is not intended to be exhaustive or to limit the invention to the precise steps and/or forms disclosed, and obviously many modifications and variations are possible in light of the above teaching.

What is claimed is:

1. A top dress seal assembly comprising:
a seal base having a first end and a second end and an opening therewithin along a longitudinal axis of said seal base between said first end and said second end, wherein said first end is configured to be positioned over a rotating shaft of a spreader and wherein said second end has one or more tabs inwardly projecting toward said longitudinal axis, said second end also having a helical engagement structure thereon;
a compression spring having a first end and a second end and being configured to be received within said opening in said seal base;
a seal lock configured to be received within said seal base, said seal lock having a first end, a second end, and a substantially cylindrical body between said first end and said second end along a longitudinal axis of said seal lock and having a slot in said first end dividing said first end into a first arm and a second arm, said first end configured to bear against said second end of said compression spring; and
a seal cap having a first end and a second end, wherein said first end has a helical engagement structure configured to couple to said helical engagement structure of said second end of said seal base.

2. The top dress seal assembly of claim 1, wherein at least one of said first arm and said second arm of said first end of said seal lock further comprises a ledge.

3. The top dress seal assembly of claim 2, wherein said first arm and said second arm are resiliently opposed to each other such that an application of a force normal to said longitudinal axis of said seal lock compresses said first arm and said second arm and moves said first arm and said second arm closer together.

4. The top dress seal assembly of claim 3, wherein said first arm and said second arm each can occupy a first configuration and a second configuration, wherein an overall diameter of said ledge at said first end of said seal lock from said first arm to said second arm is less in said second configuration than in said first configuration.

5. The top dress seal assembly of claim 1, wherein said slot is disposed substantially parallel to the longitudinal axis of said seal lock and has a slot first portion and a slot second portion.

6. The top dress seal assembly of claim 5, wherein said seal lock further comprises a horizontal slot having a horizontal slot first end and a horizontal slot second end, said horizontal slot first end in communication with said slot at said slot second portion.

7. The top dress seal assembly of claim 6, wherein said seal lock further comprises a pin seat having a bottom surface, wherein said pin seat is in communication with said horizontal slot second end.

8. The top dress seal assembly of claim 7, wherein said pin seat is situated closer to said first end of said seal lock than is said horizontal slot.

9. The top dress seal assembly of claim 1, wherein said first end of said seal base further comprises a recess configured to accept an O-ring.

10. The top dress seal assembly of claim 1, wherein said second end of said seal base further comprises a ledge protruding inwardly toward the longitudinal axis of said seal base.

11. The top dress seal assembly of claim 8, wherein said seal lock is configured to removably lock said assembly to a rotating shaft of a spreader.

12. The top dress seal assembly of claim 11, wherein when said assembly is locked to a rotating shaft of a spreader, said first end of said seal lock bears against said second end of said compression spring.

13. The top dress seal assembly of claim 12, wherein when said assembly is locked to a rotating shaft of a spreader, said compression spring urges a pin of the rotating shaft into said pin seat.

14. A top dress seal assembly comprising:
a seal base having a first end and a second end and an opening therewithin along a longitudinal axis of said seal base between said first end and said second end, wherein said first end is configured to be positioned over a rotating shaft of a spreader and further includes a ledge therewithin, and wherein said second end has one or more tabs projecting toward said longitudinal axis and also includes a helical engagement structure on an external surface;
a compression spring having a first end and a second end and being configured to be received within said opening in said seal base concentrically around said longitudinal axis;
a seal lock configured to be received within said seal base, said seal lock having a first end, a second end, and a substantially cylindrical body between said first end and said second end along said longitudinal axis, said seal lock further comprising a slot in said first end dividing said first end into a first arm and a second arm, wherein said first arm and said second arm further comprise a ledge extending radially outwardly, and wherein said slot is generally parallel to said longitudinal axis and is configured to receive a pin of a rotating shaft of the spreader, said seal lock further comprising a horizontal slot in communication with said slot, and a pin seat in communication with said horizontal slot; and
a seal cap having a first end and a second end, wherein said first end has a helical engagement structure configured to couple to said helical engagement structure of said second end of said seal base.

15. The top dress seal assembly of claim 11, wherein said first end of said seal lock is configured to bear against said second end of said compression spring.

16. The top dress seal assembly of claim 15, wherein said first end of said compression spring bears against said ledge.

17. The top dress seal assembly of claim 11, wherein said compression spring imparts a force on said seal lock that urges the pin in the rotating shaft into a bottom surface of said pin seat.

18. A method of removably coupling a top dress seal assembly to a rotating shaft of a spreader, said method comprising the steps of:
providing a seal base having a first end and a second end and a longitudinal opening therethrough, wherein said first end further comprises a ledge and said second end further comprises tabs protruding inwardly within said longitudinal opening, and said second end further includes a first coupling structure thereon;
providing a compression spring having a first end and a second end;
providing a seal lock having a first end and a second end, wherein said first end further comprises a slot separating said first end into a first arm and a second arm, and wherein said first arm and said second arm further comprise a ledge protruding outwardly away from a longitudinal axis, wherein said seal lock further comprises a horizontal slot in communication with said slot, and further comprises a pin seat in communication with said horizontal slot;
providing a seal cap having a first end and a second end wherein said first end is an open cylindrical portion having a second coupling structure thereon;
inserting said compression spring into said opening of said seal base so that said first end of said compression spring bears against said ledge;
inserting said first end of seal lock into said second end of said seal base by squeezing said first arm and said second arm together to reduce a dimension therebetween to enable pushing said seal lock past said tabs of said seal base such that a top surface of said ledge bears against a lower surface of said tabs due to a spring force of said compression spring;
inserting said first end of said seal base over a rotating shaft of a spreader such that the rotating shaft resides coaxially within said seal base, said compression spring, and said seal lock;
aligning a pin of the rotating shaft with said slot of said seal lock;
pushing said seal lock against the spring force of said compression spring until said pin reaches said horizontal slot;
rotating said seal lock toward said pin seat; and
releasing force on said seal lock to enable the pin to move into said pin seat.

19. The method of claim 18, further including the step of inserting a pin into a rotating shaft.

20. The method of claim 19, further including the step of coupling said seal cap to said seal base by engaging first coupling structure to second coupling structure.
